(19) United States
(12) Patent Application Publication
(10) Pub. No.: US 2004/0182795 A1
(43) Pub. Date: Sep. 23, 2004

(54) Apparatus and method for concentration of plasma from whole blood

(76) Inventors: Randel Dorian, San Diego, CA (US); Richard Wood Storrs, San Francisco, CA (US)

Correspondence Address: W.B. Walker Consultants, 2382 Faraday Avenue, Suite 330, Carlsbad, CA, 92008, US

(21) Appl. No.: 10/394,801

(22) Filed: Mar. 21, 2003

(51) Int. Cl. B01D 37/00

(52) U.S. Cl. 210/782

(57) ABSTRACT

A device for preparing plasma concentrate from plasma containing cells (plasma-cell mixture) comprising a centrifugal separation chamber having a plasma-cell mixture inlet port and an centrifugal separation chamber outlet port; a concentrating chamber having an inlet port and a concentrate outlet, the inlet port communicating with the centrifugal separation chamber outlet port, the concentrating chamber containing hydrogel beads and at least one inert agitator; and a concentrate chamber having an inlet communicating with the concentrate outlet through a filter, the concentrate chamber having a plasma concentrate outlet port. A method for producing plasma concentrate from plasma containing erythrocytes and platelets, comprising the steps of centrifuging a plasma-cell mixture to form an erythrocyte-rich layer and a plasma layer; moving the plasma from the plasma layer into a concentrating chamber containing hydrogel beads and an agitator to form a hydrogel bead-plasma mixture; causing the agitator to stir the hydrogel bead-plasma mixture, minimizing gel polarization and facilitating absorption of water by the beads from the plasma, until a hydrogel bead-plasma concentrate is formed; and separating plasma concentrate from the hydrogel beads from the hydrogel bead-plasma concentrate by passing the plasma concentrate through a filter.

### FIELD OF THE INVENTION

The present invention concerns devices and methods for making concentrated plasma. The present invention concerns apparatus and methods for separation and concentration of plasma and plasma platelet mixtures from plasma-erythrocyte mixtures such as whole blood and is particularly applicable to the preparation and use of autologous plasma concentrates.

Rapid fractionation of blood into erythrocyte, plasma or plasma-platelet fractions is desirable for the preparation of autologous concentrates from blood obtained from a patient during surgery. Each fraction can be modified or returned to the blood donor. Useful plasma fractions, with our without platelets, have value as sealants when concentrated without precipitation of fibrinogen, that is, when concentrated by removal of water therefrom in accordance with this invention. This invention has particular value for rapidly preparing autologous concentrated plasma fractions to help or speed healing, or as a hemostatic agent or tissue sealant.

### BACKGROUND OF THE INVENTION

Blood may be fractionated and the different fractions of the blood used for different medical needs. For instance, anemia (low erythrocyte levels) may be treated with infusions of erythrocytes. Thrombocytopenia (low thrombocyte (platelet) levels) may be treated with infusions of platelet concentrate.

Under the influence of gravity or centrifugal force, blood spontaneously sediments into layers. At equilibrium the top, low-density layer is a straw-colored clear fluid called plasma. Plasma is a water solution of salts, metabolites, peptides, and many proteins ranging from small (insulin) to very large (complement components). Plasma per se has limited use in medicine but may be further fractionated to yield proteins used, for instance, to treat hemophilia (factor VIII) or as a hemostatic agent (fibrinogen).

Following sedimentation, the bottom, high-density layer is a deep red viscous fluid comprising anuclear red blood cells (erythrocytes) specialized for oxygen transport. The red color is imparted by a high concentration of chelated iron or heme that is responsible for the erythrocytes high specific gravity. Packed erythrocytes, matched for blood type, are useful for treatment of anemia caused by, e.g., bleeding. The relative volume of whole blood that consists of erythrocytes is called the hematocrit, and in normal human beings can range from about 38% to about 54%.

Depending upon the time and speed of the centrifugation, an intermediate layer can be formed which is the smallest, appearing as a thin white band on top the erythrocyte layer and below the plasma; it is called the buffy coat. The buffy coat itself generally has two major components, nucleated leukocytes (white blood cells) and anuclear smaller bodies called platelets (thrombocytes).

Leukocytes confer immunity and contribute to debris scavenging. Platelets seal ruptures in the blood vessels to stop bleeding and deliver growth and wound healing factors to the wound site. If the centrifugation is of short duration, the platelets can remain suspended in the plasma layer.

The sedimentation of the various blood cells and plasma is based on the different specific gravity of the cells and the viscosity of the medium. This may be accelerated by centrifugation according approximately to the Svedberg equation:

V=((2/9)ω²R(d_{cells}-dₚₗₐₛₘₐ)r²)/ηₜ

where

V=sedimentation velocity,

ω=angular velocity of rotation,

R=radial distance of the blood cells to the center of the rotor,

d=specific gravity,

r=radius of the blood cells, and

ηₜ=viscosity of the medium at a temperature of t° C.

Characteristics of blood components are shown in Table A.

TABLE A

| | Diameter | Specific gravity | | |
|---|---|---|---|---|
| Component | (μm) | (g/ml) | Deformability | Adhesion |
| Red cells | 5.4 | 1.100 | +++ | − |
| Granulocytes | 9.6 | 1.085 | + | ++ |
| Lymphocytes | 7.6 | 1.070 | ± | ± |
| Monocytes | 11.2 | 1.063 | ± | + |
| Platelets | 3.2 | 1.058 | ± | +++ |
| Plasma | NA | 1.026 | NA | NA |
| Additive | NA | 1.007 | NA | NA |
| solution | | | | |

When sedimented to equilibrium, the component with the highest specific gravity (density) eventually sediments to the bottom, and the lightest rises to the top. The rate at which the components sediment is governed roughly by the Svedberg equation; the sedimentation rate is proportional to the square of the size of the component. In other words, at first larger components such as white cells sediment much faster than smaller components such as platelets; but eventually the layering of components is dominated by density.

### Soft Spin Centrifugation

When whole blood is centrifuged at a low speed (up to 1,000 g) for a short time (two to four minutes), white cells sediment faster than red cells; and both sediment much faster than platelets (according to the Svedberg equation shown above). At higher speeds the same distribution is obtained in a shorter time. This produces layers of blood components that are not cleanly separated and consist of (1) plasma containing the majority of the suspended platelets and a minor amount of white cells and red cells, and (2) below that a thick layer of red cells mixed with the majority of the white cells and some platelets. The method of harvesting platelet-rich plasma (PRP) from whole blood is based on this principle. The term “platelet-rich” is used for this component because most of the platelets in the whole blood are in the plasma following slow centrifugation so the relative concentration of platelets in the plasma has increased.

Centrifugal sedimentation that takes the fractionation only as far as separation into packed erythrocytes and PRP is called a “soft spin”. “Soft spin” is used herein to describe centrifugation conditions under which erythrocytes are sedimented but platelets remain in suspension. “Hard spin” is used herein to describe centrifugation conditions under which platelets sediment in a layer immediately above the layer of erythrocytes.

### Two Spin Platelet Separation

Following a soft spin, the PRP can removed to a separate container from the erythrocyte layer, and in a second centrifugation step, the PRP may be fractioned into platelet-poor plasma (PPP) and platelet concentrate (PC). In the second spin the platelets are usually centrifuged to a pellet to be re-suspended later in a small amount of plasma or other additive solution.

In the most common method for PRP preparation, the centrifugation of whole blood for 2 to 4 min at 1,000 g to 2,500 g results in PRP containing the majority of the platelets. After the centrifugation of a unit (450 ml) of whole blood in a 3-bag system the PRP is transferred to an empty satellite bag and next given a hard spin to sediment the platelets and yield substantially cell-free plasma. This is termed “two-spin” platelet separation.

To recover the platelets following two-spin separation, most of the platelet poor plasma (PPP) is removed except for about 50 ml and the pellet of platelets is loosened and mixed with this supernatant. Optionally one can remove about all plasma and reconstitute with additive solution. To allow aggregated platelets to recover the mixture is given a rest of one to two hours before platelets are again re-suspended and then stored on an agitator.

It is believed that two-spin centrifugation can damage the platelets by sedimenting the platelets against a solid, non-physiological surface. The packing onto such a surface induces partial activation and may cause physiological damage, producing “distressed” platelets which partially disintegrate upon resuspension.

### Hard Spin Centrifugation

If the centrifugation is continued at a low speed the white cells will sediment on top of the red cells whereas the platelets will remain suspended in the plasma. Only after extended low speed centrifugation will the platelets also sediment on top of the red cells.

Experiments with a blood processor have shown that centrifugation at a high speed (2,000 g-3,000 g) produces a similar pattern of cell separation in a shorter time. Initially the cells separate according to size, i.e., white cells sediment faster than red cells and platelets remain in the plasma. Soon the red cells get ‘packed’ on each other squeezing out plasma and white cells. Because of their lower density, white cells and platelets are pushed upwards to the interface of red cells and plasma whereas the platelets in the upper plasma layer will sediment on top of this interface, provided the centrifugal force is sufficiently high and sedimentation time is sufficiently long. Plasma, platelets, white cells and red cells will finally be layered according to their density. Platelets sedimented atop a layer of red cells are less activated than those isolated by the “two spin” technique.

### Leukoreduction

The PC's resulting from both two spin processing and apheresis methods contain donor leukocytes. The white cells negatively affect platelet storage and may induce adverse effects after transfusion due to cytokine formation. Removal of leukocytes (leukoreduction) from PRP and PC is important because non-self leukocytes (allogeneic leukocytes) and the cytokines they produce can cause a violent reaction by the recipient's leukocytes. In 1999 the FDA Blood Product Advisory Committee recommended routine leukoreduction of all non-leukocytes components in the US (Holme 2000). Therefore, much of the prior art focuses on leukoreduction of platelet concentrates because non-autologous leukocytes excite deleterious immune reactions. Since the process of this invention provides a convenient way to quickly harvest autologous platelets from the patient's blood, immune reactions are not a risk, and the presence of leukocytes is of little or no concern.

Plasma concentrates and their utility in hemostasis and wound healing have been described in U.S. Pat. No. 5,585,007. Plasma concentrates can be made in a two-step method, first separating of plasma from the majority of erythrocytes and then concentrating the plasma by removing water. The plasma can be separated from the erythrocytes by centrifugation. The water can be removed from the plasma using a semipermeable membrane or by contact with a desiccated hydrogel bead. The membrane and hydrogel bead pores allow passage of water, salts and other low molecular weight components while blocking passage of cells, platelets (thrombocytes), cell fragments and larger molecules such as fibrinogen. The passage of water and low molecular weight components through the membrane or into the bead concentrates the plasma, the cells and high molecular weight components contained therein. The dry hydrogel beads can be dextranomer or polyacrylamide.

Recent publications report that platelet preparations enhance the healing rate of hard and soft tissue defects. Activated cytokine proteins, released from activated platelets, signal the migration, proliferation and activation of monocyte cells. Monocyte cells sense a gradient of cytokines and migrate towards the source.

Fibers of polymerized fibrin form pathways by which monocyte cells translocate into the wound. Translocation is enhanced by tension on these fibers imparted by the action of platelet microtubules during clot retraction. Therefore, in situ polymerization of platelet-containing fibrinogen solutions provides an enhanced setting for wound healing. Platelet-plasma concentrates provide enhanced signals and pathways for wound healing cell migration.

Platelets have a limited half-time in vivo, and platelet activity declines rapidly ex vivo. An optimal wound-healing compound therefore would contain freshly isolated platelets. To minimize risk of disease transmission and maximize beneficial patient response to platelet activity the platelet/plasma concentrate would preferably be prepared from the patient's own blood, i.e. autologously. The amount of blood withdrawn from the patient should be as small as possible to minimize morbidity caused by blood loss.

The present invention provides methods and apparatus for rapidly separating patient plasma from whole blood, contacting said plasma with dry hydrogel beads, concentrating said plasma, and separating the resulting plasma concentrate from the beads for application to patient wounds.

### SUMMARY OF THE INVENTION

This invention relates to a device for preparing plasma concentrate from plasma containing cells (plasma-cell mixture) comprising a centrifugal separation chamber having a plasma-cell mixture inlet port and a centrifugal separation chamber outlet port. The concentrating chamber has an inlet port and a concentrate outlet, the inlet port communicating with the centrifugal separation chamber outlet port, the concentrating chamber containing hydrogel beads and at least one inert agitator. The device also includes a concentrate chamber having an inlet communicating with the concentrate outlet through a filter, the concentrate chamber having a plasma concentrate outlet port. A plunger can be positioned in the concentrating chamber. The concentrating chamber has an inner concentrating chamber wall, the plunger having an outer edge surface conforming to a surface of the inner concentrating chamber wall; and the hydrogel beads and agitator can be positioned in the concentrating chamber between the plunger and the filter. The outer edge surface of the piston can form a sealing engagement with the surface of the inner concentrating chamber wall.

In one embodiment, the centrifugal separation chamber has an erythrocyte-plasma interface level, and the centrifugal chamber outlet port is positioned above the erythrocyte-plasma interface level. The concentrating chamber can have an unconcentrated plasma-air interface level, the centrifugal separation chamber outlet port and the concentrating chamber inlet port form an open passageway for flow of plasma, and the concentrating chamber inlet port is positioned at a level above said plasma-air interface level. Alternatively, the centrifugal separation chamber can have a one-way valve permitting flow of plasma from the centrifugal separation chamber into the concentrating chamber.

In these embodiments, the agitator can be a dense object such as a smooth ball which can be a stainless steel. The filter can be a porous frit.

The term “plasma concentrate” is defined to include both plasma concentrate with platelets and plasma concentrate without platelets.

A method of this invention for producing plasma concentrate from plasma containing erythrocytes and platelets can comprise the steps of (a) centrifugally separating a plasma-cell mixture to form an erythrocyte-rich layer and a plasma layer; (b) moving the plasma from the plasma layer into a concentrating chamber containing hydrogel beads and an agitator to form a hydrogel bead-plasma mixture; (c) causing the agitator to stir the hydrogel bead-plasma mixture, minimizing gel polarization and facilitating absorption of water by the beads from the plasma, until a hydrogel bead-plasma concentrate is formed; and (d) separating plasma concentrate from the hydrogel beads from the hydrogel bead-plasma concentrate by passing the plasma concentrate through a filter. The hydrogel beads can have the effective absorption capacity to remove at least 10 percent of the water from the plasma, at least 25 percent of the water from the plasma, or at least 50 percent of the water from the plasma.

The plasma containing erythrocytes and platelets can be whole blood.

The invention can be a method for producing plasma concentrate with a plasma concentrating device comprising a centrifugal separation chamber having a plasma-cell mixture inlet port and an centrifugal separation chamber outlet port; a concentrating chamber having a inlet port and a concentrate outlet, the inlet port communicating with the centrifugal separation chamber outlet port, the concentrating chamber containing hydrogel beads and at least one inert agitator; and a concentrate chamber having an inlet communicating with the concentrating outlet through a filter, the concentrate chamber having a plasma concentrate outlet port. With this device, the method can comprise (a) centrifuging a plasma-cell mixture in the centrifugal separation chamber to form an erythrocyte-rich layer and a plasma layer; (b) moving the plasma from the plasma layer through the separation chamber outlet port through the inlet port of the concentrating chamber to form a hydrogel bead-plasma mixture; (c) causing the agitator to stir the hydrogel bead-plasma mixture, minimizing gel polarization and facilitating absorption of water by the beads from the plasma, until a hydrogel bead-plasma concentrate is formed; and (d) separating plasma concentrate from the hydrogel beads from the hydrogel bead-plasma concentrate by passing the plasma concentrate through the filter and the concentrating chamber outlet port.

In this method, a plunger can be positioned in the concentrating chamber, the hydrogel beads and agitator are positioned in the concentrating chamber between the plunger and the filter, and the concentrating chamber has an inner concentrating chamber wall, the plunger having an outer edge surface conforming to a surface of the inner concentrating chamber wall. With this variation of the device, the method can comprise (a) centrifuging a plasma-cell mixture in the centrifugal separation chamber to form an erythrocyte-rich layer and a plasma layer; (b) moving plasma from the plasma layer through the inlet/outlet port and the filter by axial movement of the plunger in the proximal direction away from the filter; (c) moving the plasma concentrating device in alternative distal and proximal directions along the central axis of the concentrating chamber to stir the hydrogel bead-plasma mixture, minimizing gel polarization and facilitating absorption of water by the beads from the plasma, until a hydrogel bead-plasma concentrate is formed; and (d) separating plasma concentrate from hydrogel beads by moving the plasma concentrate through the filter. In step (d) the plasma concentrate can be moved through the filter and into the concentrate outlet by moving the plunger in the distal direction toward the filter. Other means of moving the plasma concentrate through the filter are within the intended scope of this invention, such as movement by centrifugal force or suction, for example.

### BRIEF DESCRIPTION OF THE DRAWINGS

FIG. 1 is a cross-sectional schematic view of the apparatus of this invention for producing plasma concentrate from plasma-cell mixtures such as whole blood.

FIGS. 2-8 are cross-sectional representations showing the apparatus of FIG. 1 in the sequential stages of the method of this invention.

FIG. 9 is a cross-sectional schematic view of another apparatus of this invention for producing plasma concentrate from plasma-cell mixtures such as whole blood.

FIGS. 10-16 are cross-sectional schematic representations showing the apparatus of FIG. 9 in the sequential stages of the method of this invention.

### DETAILED DESCRIPTION OF THE INVENTION

The apparatus and methods of this invention offer inexpensive streamlined systems for rapidly preparing plasma concentrates. The entire process, from extracting whole blood to applying plasma concentrates can be accomplished in less than ten minutes. The product can be cell-free plasma concentrate, or if desired, plasma concentrates containing platelets.

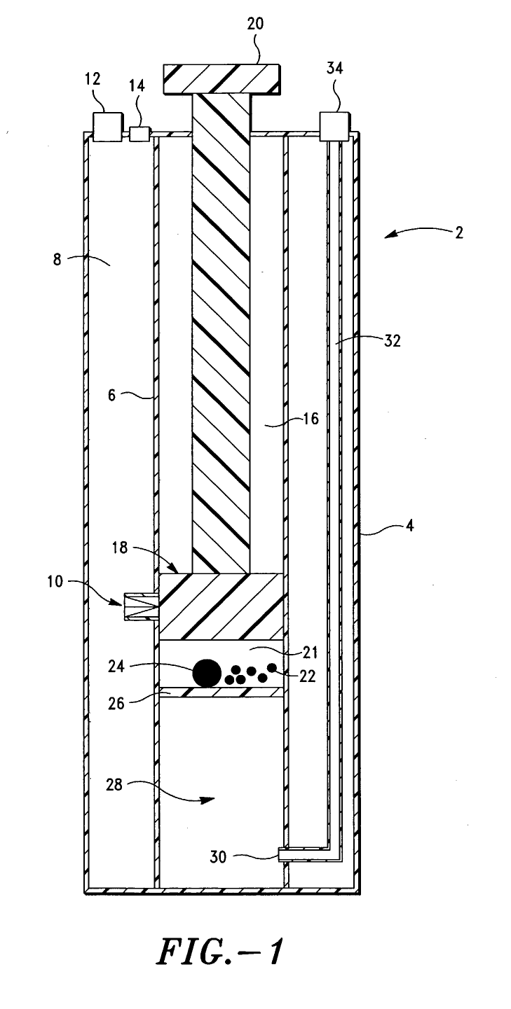

FIG. 1 is a cross-sectional schematic view of the concentrator apparatus of this invention for producing plasma concentrate from plasma-cell mixtures such as whole blood. The concentrator 2 comprises a centrifugal separation chamber 8 defined by an outer wall 4 and an inner wall 6. The centrifugal separation chamber 8 has an outlet passageway 10 with a check valve permitting one-way flow of liquid from the centrifugal separation chamber. The centrifugal separation chamber 8 has an inlet port 12 for introducing plasma-cell mixtures such as whole blood, and an air vent 14 to permit escape of air displaced by liquid as it is introduced through the inlet port 12. The inlet port 12 can be adapted for junction with a syringe and have a Luer fitting. The inner wall 6 defines a concentrating chamber 16. In the embodiment of FIG. 1, the concentrating chamber is enclosed within the centrifugal separation chamber and can be axially concentric therewith. It will be readily apparent to a person skilled in the art that the shapes can be cylindrical or other shapes and the relationships between these chambers can be axially concentric or other relationships without departing from the invention, all of these shapes and relationships are intended to be within the scope of this invention.

A plunger 18 is positioned in the concentration chamber for motion along its central axis and the central axis of the concentration chamber. The plunger is connected to a plunger actuator 20 which extends outside of the concentration chamber for manual or robotic movement of the plunger. In the bead chamber portion 21 of the concentrating chamber volume 16 defined by the plunger 18 and the filter 26 are positioned desiccated hydrogel beads 22 and an agitator 24.

The hydrogel beads are insoluble beads or disks which will absorb a substantial volume of water and not introduce any undesirable contaminant into the plasma. They can be dextranomer or acrylamide beads which are commercially available (Debrisan from Pharmacia and BIO-GEL p™ from Bio-Rad Laboratories, respectively). Alternatively, other concentrators can be used, such as SEPHADEXTM moisture or water absorbants (available from Pharmacia), silica gel, zeolites, cross-linked agarose, etc., in the form of insoluble inert beads or discs.

The agitator 24 is a dense object which can be an inert metal sphere. It will be readily apparent to a person skilled in the art that the shape, composition and density of the agitator 24 can vary widely without departing from the invention so long as the agitator has a density substantially greater than hydrated hydrogel beads. It is advantageous that the agitator be a metal sphere such as a titanium or stainless steel sphere which will not react with blood components, or a dense sphere coated with an inert coating such as TEFLON or similar insert polymer which will not react with blood components.

The filter 26 can be any inert mesh or porous materials which will permit the passage of platelets in the plasma and exclude the hydrogel beads and agitator. The filter can be a metal wire or inert fiber frit of either woven or non-woven composition, or any other frit construction which, when the liquid in the concentration chamber is passed through the filter, will permit passage of the platelets in the plasma and not the hydrogel beads and agitator, effectively separating the platelets and plasma from the hydrogel beads and agitator as will be described in greater detail with respect to FIGS. 2-8 hereinafter.

The concentrate chamber 28, separated from the concentrating chamber 21 by filter 26, is positioned to receive plasma concentrate after it passes through the filter 26. The concentrate chamber 28 has a concentrate outlet port 30 which communicates with the concentrate extraction port 34 through concentrate channel 32. The concentrate extraction port 34 can be adapted for junction with a syringe and have a Luer fitting.

FIGS. 2-8 are cross-sectional representations showing the apparatus of FIG. 1 in the sequential stages of the method of this invention. In the explanation, the operation of the device of FIG. 1 will be explained with respect to the treatment of whole blood for purposes of clarifying the description, but it is intended to apply to the treatment of any plasma-cell mixture.

FIG. 2 is a cross-sectional schematic drawing showing the concentrator device 2 of FIG. 1 before use.

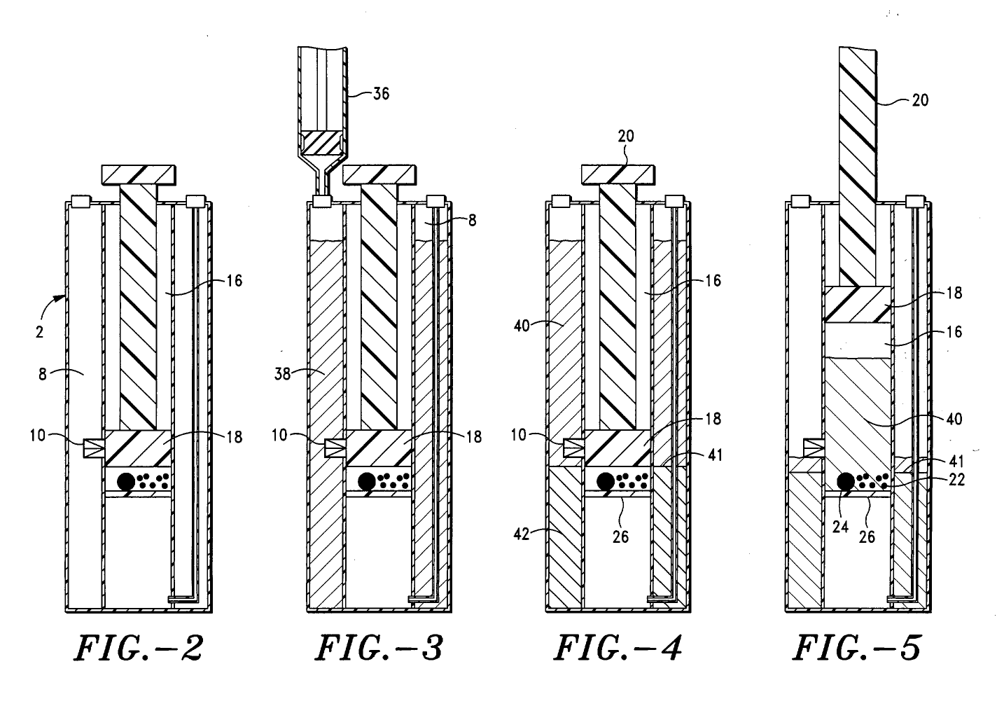

FIG. 3 shows the concentrator device 2 after the centrifugal separation chamber 8 has been filled with blood. A syringe 36 originally filled with blood has been coupled with inlet port fitting 12, and blood 38 has been expelled from the syringe to fill the centrifugal separation chamber 8. The blood remains in the centrifugal separation chamber 8 because the plunger 18 remains in a position blocking the check valve 10.

FIG. 4 shows the concentrator device 2 after the device has been centrifuged, the centrifugal forces forcing the erythrocytes and leukocytes to settle into a dense layer 42, above which the plasma 40, now free of erythrocytes rest. The plasma remains in the centrifugal separation chamber 8 because the plunger 18 remains in a position blocking the check valve 10.

Depending upon the centrifugation conditions, the plasma layer 40 can contain platelets. The plasma 40 forms an interface with the erythrocytes 42. The actual level of the plasma-erythrocyte interface 41 will vary with the hematocrit of the blood. The plasma-erythrocyte interface 41 is defined as the interface level obtained with the maximum possible hematocrit, that is, with blood having a maximum erythrocyte/plasma ratio. The passageway 10 is positioned to be above the interface level 41 to prevent flow of erythrocytes therethrough. The plasma 40 remains in the centrifugal separation chamber 8 because the plunger 18 remains in a position blocking the passageway 10.

FIG. 5 shows the concentrator device 2 after the plunger 18 has been raised, unblocking passageway 10, and drawing the plasma 40 through the check valve 10 into the bead chamber portion 21 (FIG. 1) of the concentrating chamber 16 and into contact with the desiccated hydrogel beads 26. At this stage, the concentrator device 2 is moved in a reciprocal motion back and forth along its central axis to move the agitator through the plasma-bead mixture. This stirs the beads, minimizing gel polarization and increasing the absorption of water from the plasma into the beads.

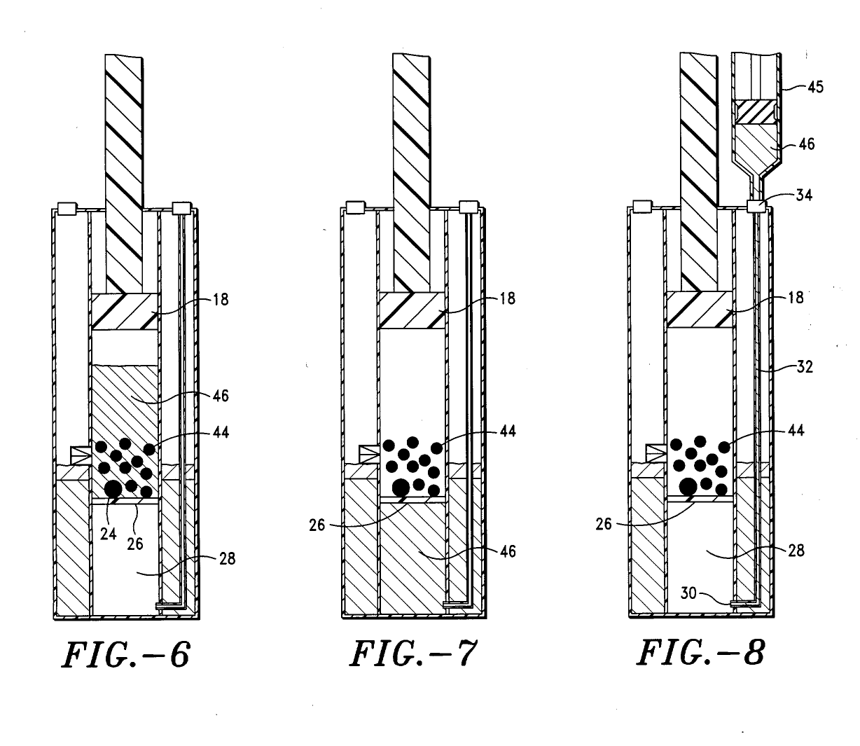

FIG. 6 shows the concentrator device 2 after water absorption from the beads into the hydrogel beads, shown by the enlarged size of the hydrated hydrogel beads 44, and formation of the plasma concentrate 46.

FIG. 7 shows the concentrator device 2 after the plasma concentrate 46 has passed through the filter 26. Passage of the plasma concentrate 46 through the filter can be effected by centrifuging the concentration device to cause centrifugal forces to move the plasma concentrate through the filter into the concentrate chamber 28. Alternatively, the plunger can be lowered (not shown) to press the plasma concentrate through the filter into the concentrate chamber 28. Centrifugal force provides an increased yield of plasma concentrate since it can cause the liquid to flow away from the hydrated gel beads 44, a function which depressing the plunger 18 cannot provide.

FIG. 8 shows the removal of plasma concentrate from the concentrate chamber 28 by the syringe 45 (which can be a new syringe or syringe 36), the plasma concentrate being drawn by the syringe through the concentrate outlet port 30 through the channel 32 and out the concentrate extraction port 34.

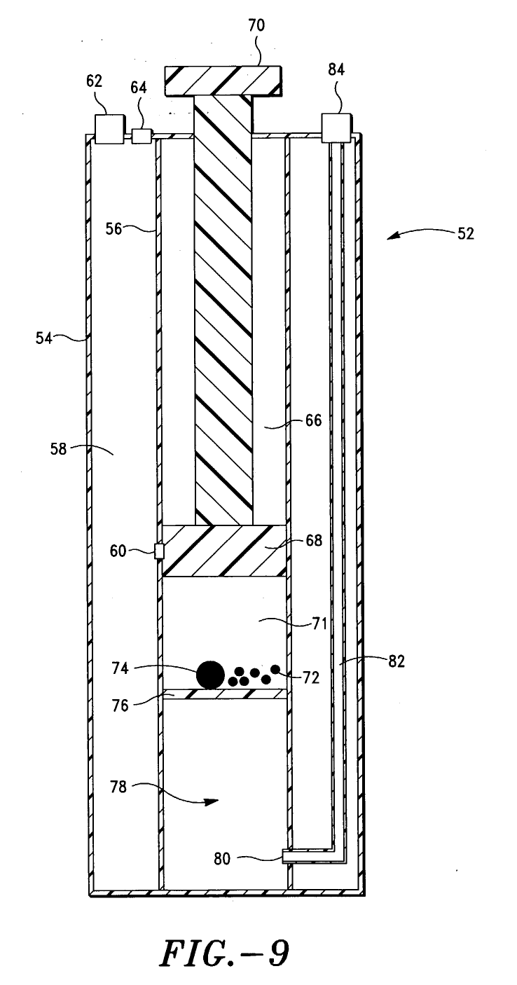

FIG. 9 is a cross-sectional schematic view of another apparatus of this invention for producing plasma concentrate from plasma-cell mixtures such as whole blood. The concentrator 52 comprises a centrifugal separation chamber 58 defined by an outer wall 54 and an inner wall 56. The centrifugal separation chamber 58 has an open outlet passageway 60 which is positioned to be always above the cell-plasma interface in the centrifugal separation chamber after centrifugation. The centrifugal separation chamber 58 has an inlet port 62 for introducing plasma-cell mixtures such as whole blood, and an air vent 64 to permit escape of air displaced by liquid as it is introduced through the inlet port 62. The inlet port 62 can be adapted for junction with a syringe and have a Luer fitting. The inner wall 56 defines a concentrating chamber 66. In the embodiment of FIG. 9, the concentrating chamber is enclosed within the centrifugal separation chamber and can be axially concentric therewith. It will be readily apparent to a person skilled in the art that the shapes can be cylindrical or other shapes and the relationships between these chambers can be axially concentric or other relationships without departing from the invention, and all of these shapes and relationships are intended to be within the scope of this invention.

A plunger 68 is positioned in the concentration chamber for motion along its central axis and the central axis of the concentration chamber. The plunger is connected to a plunger actuator 70 which extends outside of the concentration chamber for manual or robotic movement of the plunger. Desiccated hydrogel beads 72 and an agitator 74 are positioned in the bead chamber portion 71 of the concentrating volume defined by the plunger 68 and the filter 76.

As described with respect to FIG. 1, the hydrogel beads are insoluble beads or disks which will absorb a substantial volume of water and not introduce any undesirable contaminant into the plasma. They can be dextranomer or acrylamide beads which are commercially available (Debrisan from Pharmacia and BIO-GEL P™ from Bio-Rad Laboratories, respectively). Alternatively, other concentrators can be used, such as SEPHADEXTM moisture or water absorbants (available from Pharmacia), silica gel, zeolites, cross-linked agarose, etc., in the form of insoluble inert beads or discs.

The agitator 74 is a dense object which can be an inert metal sphere. It will be readily apparent to a person skilled in the art that the shape, composition and density of the agitator 74 can vary widely without departing from the invention so long as the agitator has a density substantially greater than whole blood. It is advantageous that the agitator be a metal sphere such as a titanium or steel sphere which will not react with blood components, or an dense sphere coated with an inert coating which will not react with blood components.

The filter 76 can be any inert mesh or porous materials which will permit the passage of platelets and plasma and exclude the hydrogel beads and agitator. The filter can be a metal wire or inert fiber frit of either woven or non-woven composition, or any other frit construction which, when the liquid in the concentration chamber is passed through the filter, will permit passage of the platelets and plasma and not the hydrogel beads and agitator, effectively separating the plasma concentrate from the hydrogel beads and agitator as will be described in greater detail with respect to FIGS. 2-8 hereinafter.

The concentrate chamber 78, separated from the bead chamber 71 by filter 76, is positioned to receive plasma after it passes through the filter 76. The concentrate chamber 78 has a concentrate outlet port 80 which communicates with the concentrate extraction port 84 through concentrate channel 82. The concentrate extraction port 84 can be adapted for junction with a syringe and have a Luer fitting.

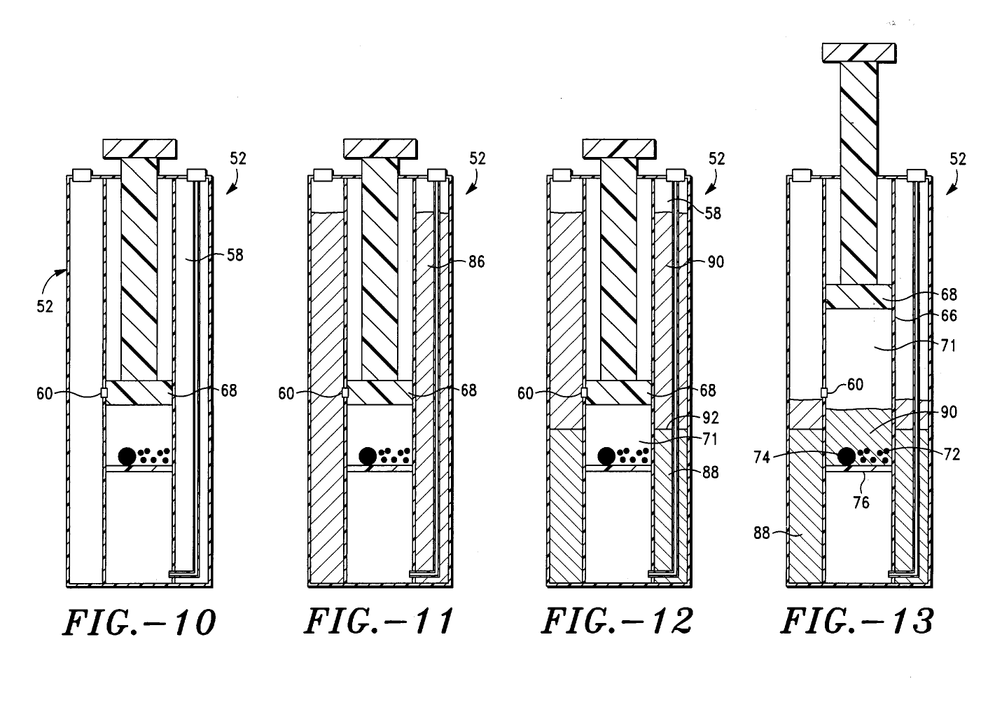

FIGS. 10-16 are cross-sectional schematic representations showing the apparatus of FIG. 9 in the sequential stages of the method of this invention.

FIG. 10 is a cross-sectional schematic drawing showing the concentrator device of FIG. 9 before use, with the plunger 68 positioned to block the passageway 60.

FIG. 11 shows the concentrator device 52 of FIG. 10 after the centrifugal separation chamber 58 has been filled with blood 86, for example from a syringe (as described above with respect to FIG. 3). The blood remains in the centrifugal separation chamber 58 because the plunger 68 remains in a position blocking the passageway 60.

FIG. 12 shows the concentrator device 52 after the device has been centrifuged, the centrifugal forces forcing the erythrocytes or cells to settle into an erythrocyte layer 88, above which the plasma layer 90, now free of erythrocytes. Depending upon the centrifugation conditions, the plasma layer 90 can contain platelets. The plasma 90 forms an interface with the erythrocytes. The actual level of the plasma-erythrocyte interface will vary with the hematocrit of the blood. The plasma-erythrocyte interface 92 is defined as the interface level obtained with the maximum possible hematocrit, that is, with blood having a maximum erythrocyte/plasma ratio. The passageway 60 is positioned to be above the interface level 92 to prevent flow of erythrocytes therethrough. The plasma 90 remains in the centrifugal separation chamber 58 because the plunger 68 remains in a position blocking the passageway 60.

FIG. 13 shows the concentrator device 52 after the plunger 68 has been raised, unblocking passageway 60, drawing the plasma 90 through the passageway 60 into the bead chamber portion 71 of the concentrating chamber 66 and into contact with the desiccated hydrogel beads 72. The filter 76 is positioned at a level which provides a volume, in the concentration chamber 71 between the filter 76 and the passageway 60 which exceeds the volume of plasma above the passageway 60 in the centrifugal separation chamber 58 (See FIG. 12). At this stage, the concentrator device 52 is moved in a reciprocal motion back and forth along its central axis to move the agitator 74 through the plasma-hydrogel bead mixture. This stirs the beads 72, increasing the absorption of water from the plasma into the beads.

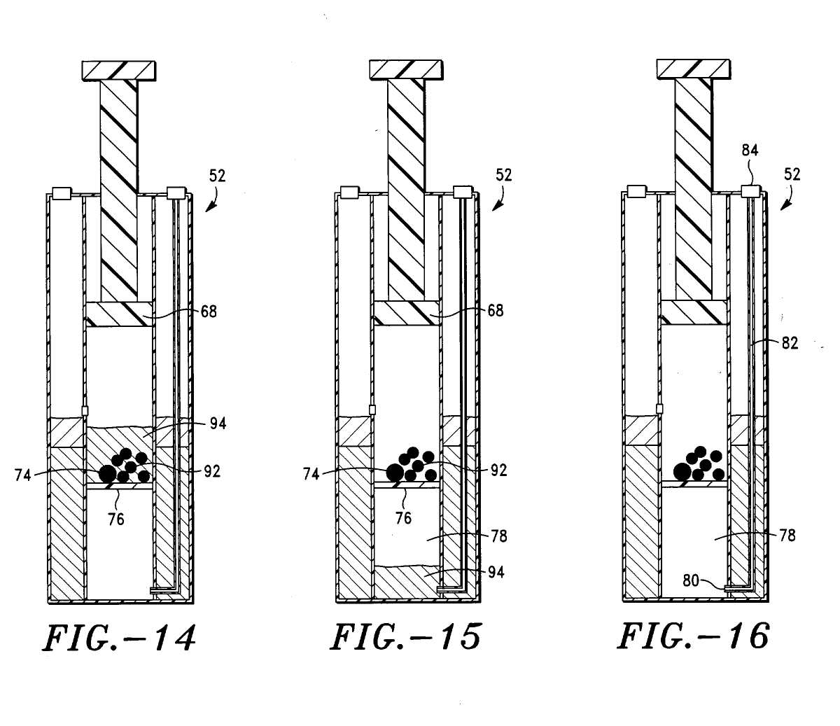

FIG. 14 shows the concentrator device 52 after water absorption from the beads into the hydrogel beads, shown by the enlarged size of the hydrated hydrogel beads 92, and formation of the plasma concentrate 94.

FIG. 15 shows the concentrator device 52 after the plasma concentrate 94 has passed through the filter 76. Passage of the plasma concentrate 94 through the filter 76 can be effected by centrifuging the concentration device to cause centrifugal forces to move the plasma concentrate through the filter into the concentrate chamber 78. Alternatively, suction can be applied to draw the plasma concentrate through the filter into the concentrate chamber 78. Centrifugal force provides an increased yield of plasma concentrate since it will cause the liquid to flow away from the hydrated gel beads 92 and agitator 74.

FIG. 16 shows the chamber 78 after removal of plasma concentrate 94 from the concentrate, for example with a syringe as shown in FIG. 8, the plasma concentrate having been extracted through the concentrate outlet port 80 through the channel 82 and out the concentrate extraction port 84.

The invention claimed is:

1. A device for preparing plasma concentrate from plasma containing cells (plasma-cell mixture) comprising
a centrifugal separation chamber having a plasma-cell mixture inlet port and a centrifugal separation chamber outlet port;
a concentrating chamber having an inlet port and a concentrate outlet, the inlet port communicating with the centrifugal separation chamber outlet port, the concentrating chamber containing hydrogel beads and at least one inert agitator; and
a concentrate chamber having an inlet communicating with the concentrating chamber outlet through a filter, the concentrate chamber having an plasma concentrate outlet port.

2. A device for preparing plasma concentrate of claim 1 wherein
a plunger is positioned in the concentrating chamber and the concentrating chamber having an inner concentrating chamber wall, the plunger having an outer edge surface conforming to a surface of the inner concentrating chamber wall; and the hydrogel beads and agitator are positioned in the concentrating chamber between the plunger and the filter.

3. A plasma concentrator of claim 2 wherein the concentration chamber has an inner wall surface, and the plunger is a piston forming a sealing engagement with the an inner wall surface.

4. A device for preparing plasma concentrate of claim 2 wherein the centrifugal separation chamber has a erythrocyte-plasma interface level, and the centrifugal chamber outlet port is positioned above the erythrocyte-plasma interface level.

5. A device for preparing plasma concentrate of claim 4 wherein the concentrating chamber has an unconcentrated plasma-air interface level, the centrifugal separation chamber outlet port and the concentrating chamber inlet port form an open passageway for flow of plasma, and the concentrating chamber inlet port is positioned at a level above said plasma-air interface level.

6. A device for preparing plasma concentrate of claim 4 wherein the centrifugal separation chamber has a one-way valve permitting flow of plasma from the centrifugal separation chamber into the concentrating chamber.

7. A plasma concentrator of claim 1 wherein an agitator is a dense object.

8. A plasma concentrator of claim 7 wherein an agitator is a smooth ball.

9. A plasma concentrator of claim 8 wherein the agitator is a metal ball having an inert surface which will not react with blood components.

10. A plasma concentrator of claim 1 wherein the filter is a porous frit.

11. A method for producing plasma concentrate from plasma containing erythrocytes and platelets, comprising the steps of
a) centrifuging a plasma-cell mixture to form an erythrocyte-rich layer and a plasma layer;
b) moving the plasma from the plasma layer into a concentrating chamber containing hydrogel beads and an agitator to form a hydrogel bead-plasma mixture;
c) causing the agitator to stir the hydrogel bead-plasma mixture, facilitating absorption of water by the beads from the plasma, until a hydrogel bead-plasma concentrate is formed; and
d) separating plasma concentrate from the hydrogel beads from the hydrogel bead-plasma concentrate by passing the plasma concentrate through a filter.

12. A method of claim 11 wherein the hydrogel beads have the effective absorption capacity to remove at least 10 percent of the water from the plasma.

13. A method of claim 11 wherein the hydrogel beads have the effective absorption capacity to remove at least 25 percent of the water from the plasma.

14. A method of claim 11 wherein the hydrogel beads have the effective absorption capacity to remove at least 50 percent of the water from the plasma.

15. A method of claim 11 wherein the plasma containing erythrocytes and platelets is whole blood.

16. A method for producing plasma concentrate with a plasma concentrating device comprising a centrifugal separation chamber having a plasma-cell mixture inlet port and an centrifugal separation chamber outlet port;
a concentrating chamber having a inlet port and a concentrate outlet, the inlet port communicating with the centrifugal separation chamber outlet port, the concentrating chamber containing hydrogel beads and at least one inert agitator; and a concentrate chamber having an inlet communicating with the concentrating chamber outlet through a filter, the concentrate chamber having a plasma concentrate outlet port, the method comprising:
a) centrifuging a plasma-cell mixture in the centrifugal separation chamber to form an erythrocyte-rich layer and a plasma layer;
b) moving the plasma from the plasma layer through the centrifugal separation chamber outlet port through the inlet port of the concentrating chamber to form a hydrogel bead-plasma mixture;
c) causing the agitator to stir the hydrogel bead-plasma mixture, facilitating absorption of water by the beads from the plasma, until a hydrogel bead-plasma concentrate is formed; and
d) separating plasma concentrate from the hydrogel beads from the hydrogel bead-plasma concentrate by passing the plasma concentrate through the filter and the plasma concentrate outlet port.

17. A method of claim 16 wherein the hydrogel beads have the effective absorption capacity to remove at least 10 percent of the water from the plasma.

18. A method of claim 16 wherein the hydrogel beads have the effective absorption capacity to remove at least 25 percent of the water from the plasma.

19. A method of claim 16 wherein the hydrogel beads have the effective absorption capacity to remove at least 50 percent of the water from the plasma.

20. A method for producing plasma concentrate of claim 16 wherein a plunger is positioned in the concentrating chamber, the hydrogel beads and agitator are positioned in the concentrating chamber between the plunger and the filter, and the concentrating chamber has an inner concentrating chamber wall, the plunger having an outer edge surface conforming to a surface of the inner concentrating chamber wall, the method comprising:
a) centrifuging a plasma-cell mixture in the centrifugal separation chamber to form an erythrocyte-rich layer and a plasma layer;
b) moving plasma from the plasma layer through the inlet/outlet port and the filter by axial movement of the plunger in the proximal direction away from the filter;
c) moving the plasma concentrating device in alternative distal and proximal directions along the central axis of the concentrating chamber to stir the hydrogel bead-plasma mixture, facilitating absorption of water by the beads from the plasma, until a hydrogel bead-plasma concentrate is formed; and
d) separating plasma concentrate from hydrogel beads by moving the plasma concentrate through the filter.

21. A method of claim 20 wherein in step (d) the plasma concentrate is moved through the filter and into the concentrate chamber by moving the plunger in the distal direction toward the filter.

22. A method of claim 20 wherein in step (d) the plasma concentrate is forced through the filter by centrifugal force.

23. A method of claim 20 wherein in step (d) the plasma concentrate is drawn through the filter by suction.
